(19) United States
(12) Patent Application Publication
(10) Pub. No.: US 2004/0006530 A1
(43) Pub. Date: Jan. 8, 2004

(54) Automated lotting

(75) Inventors: John Eugene Allamon, Erie, PA (US); Daniel Martin Jakopin, Pittsburgh, PA (US); William R. Blair, Gibsonia, PA (US)

Correspondence Address: Daniel H. Golub, Morgan, Lewis & Bockius LLP, 1701 Market Street, Philadelphia, PA, 19103, US

(73) Assignee: FreeMarkets, Inc.

(21) Appl. No.: 10/614,331

(22) Filed: Jul. 3, 2003

Related U.S. Application Data
(60) Provisional application No. 60/393,426, filed on Jul. 3, 2002.

(51) Int. Cl. G06F 17/60

(52) U.S. Cl. 705/37

(57) ABSTRACT

A method, system and machine readable code for creating a lot having a plurality of items to be auctioned in an electronic auction based on common attributes of the items. An electronic database is provided containing a listing of items, including the items to be auctioned. Each item in the listing of items has at least one attribute and each attribute is common to a plurality of items in the listing of items. At least one attribute is identified where the attribute characterizes at least one of the items to be auctioned. The database is searched to compile an identified listing of items. Each item in the identified listing of items has the at least one identified attribute. Lastly, a lot listing is generated from the identified listing of items.

### REFERENCE TO RELATED APPLICATION

This application claims priority of copending U.S. provisional application No. 60/393,426 filed on Jul. 3, 2002.

### FIELD OF INVENTION

This invention relates generally to online electronic auctions and in particular, to automated lotting in electronic auctions.

### BACKGROUND OF THE INVENTION

Procurement of supplies has traditionally involved high transaction costs, especially information search costs. The introduction of electronic commerce has introduced new methods of procurement that lower some of the transaction costs associated with procurement. Online procurement, or business-to-business electronic commerce, matches buyers and suppliers so that transactions can take place electronically.

There are several models of online procurement, including catalog, buyer-bidding auctions, seller bidding auctions, and exchange marketplaces. In a buyer-bidding auction, bid prices may start low and move upward in an auction format as buyers interact to establish a closing price. The auction marketplace is often one-sided, i.e., one supplier and many potential buyers. It is believed that, typically, the products being purchased are components or materials. “Components” may mean fabricated tangible pieces or parts that become part of assemblies of durable products. Example components may include gears, bearings, appliance shelves, or door handles. “Materials” may mean bulk quantities of raw materials that are further transformed into product. Example materials include corn syrup or sheet steel.

The success of an online procurement including an online electronic auction, depends upon multiple considerations. The grouping of items as a single entity based on defined characteristics, or lotting, is on such consideration. It takes a considerable amount of time to determine the proper lotting for items when there are a large number of complex items to be lotted. The accuracy of the lotting can also be less than optimum.

### SUMMARY OF THE INVENTION

The present invention provides a method for creating a lot having a plurality of items to be auctioned in an electronic auction based on common attributes of the items. An electronic in the listing of items has at least one attribute and each attribute is common to a plurality of items in the listing of items. At least one attribute is identified where the attribute characterizes at least one of the items to be auctioned. The database is searched to compile an identified listing of items. Each item in the identified listing of items has the at least one identified attribute. Lastly, a lot listing is generated from the identified listing of items.

The invention also provides for a method for creating a lot having a plurality of items to be auctioned in an electronic auction based on common attributes of the items. An electronic database is provided having an attribute-based electronically searchable list of a plurality of attributes and a listing of items, including the items to be auctioned. Each item in the listing of items has at least one attribute and each attribute is common to a plurality of items in the listing of items. At least one attribute is identified where the attribute characterizes at least one of the items to be auctioned. The database is searched to compile an identified listing of items. Each item in the identified listing of items having the at least one identified attribute and an index of the total number of items per each identified attribute. A lot listing is generated from the identified listing of items by grouping attributes with similar characteristics and prices; and selecting the items in the lot listing having the identified attributes. Lastly, the generated lots are displayed in an organized manner.

The invention also provides for a system for creating a lot having a plurality of items to be auctioned in an electronic auction based on common attributes of the items. The system includes a database for storing a listing of items, including the items to be auctioned. It also includes software for: choosing at least one attribute of at least one of the items to be auctioned; searching the database to compile an identified listing of items; and generating a lot listing from the identified listing of items.

The invention also provides for a machine readable medium that creates a lot having a plurality of items to be auctioned in an electronic auction based on common attributes of the items. The machine readable code includes: a first machine readable code that stores a listing of items, including the items to be auctioned; a second machine readable code that identifies at least one attribute of at least one of the items to be auctioned; a third machine readable code that searches the database to compile an identified listing of items; and a fourth machine readable code that generates a lot listing from the identified listing of items.

### BRIEF DESCRIPTION OF THE DRAWINGS

The accompanying drawings, which are incorporated herein and constitute a part of this specification, illustrate the presently preferred embodiments of the invention and, together with the general description given above and the detailed description given below, serve to explain the features of the invention.

FIG. 1A is a flow diagram of a request for quotation in an auction;

FIG. 1B is a flow diagram of a bidding process in an auction;

FIG. 2 illustrates individual part attributes of an embodiment of the invention;

FIG. 3 illustrates part attributes for multiple parts of an embodiment of the invention;

FIG. 4 is a flow diagram illustrating a method of a preferred embodiment of the present invention;

FIG. 5A illustrates an editing screen used in one embodiment of the invention;

FIG. 5B illustrates an editing screen of another embodiment of the invention;

FIG. 6 is a schematic illustration of communications links between the coordinator, the buyer, and the suppliers in an auction; and

FIG. 7 is a schematic illustration of auction software and computers hosting the software in an auction.

### DETAILED DESCRIPTION OF THE PREFERRED EMBODIMENTS

Reference will now be made in detail to the preferred embodiments of the present invention, examples of which are illustrated in the accompanying drawings. It is to be understood that the Figures and descriptions of the present invention included herein illustrate and describe elements that are of particular relevance to the present invention, while eliminating, for purposes of clarity, other elements found in typical auction systems and computer networks.

This invention provides a method for creating a lot having a plurality of items to be auctioned in an electronic auction based on common attributes of the items. The invention is designed to create logical groupings of a plurality of items in an auction. The invention is particularly applicable to parts, buy may also apply to materials, goods, components, or any other sellable item. To create the lot, each of the part attributes of each individual part is analyzed and then grouped into lots based on like processes needed to produce them, for example. Like parts are placed in the same lot.

The following description of the features of the present invention is presented in the context of downward-based online industrial auctions. However, as would be appreciated by one of ordinary skill in the relevant art, these inventive features could be applied in the context of upward-based online auctions as well.

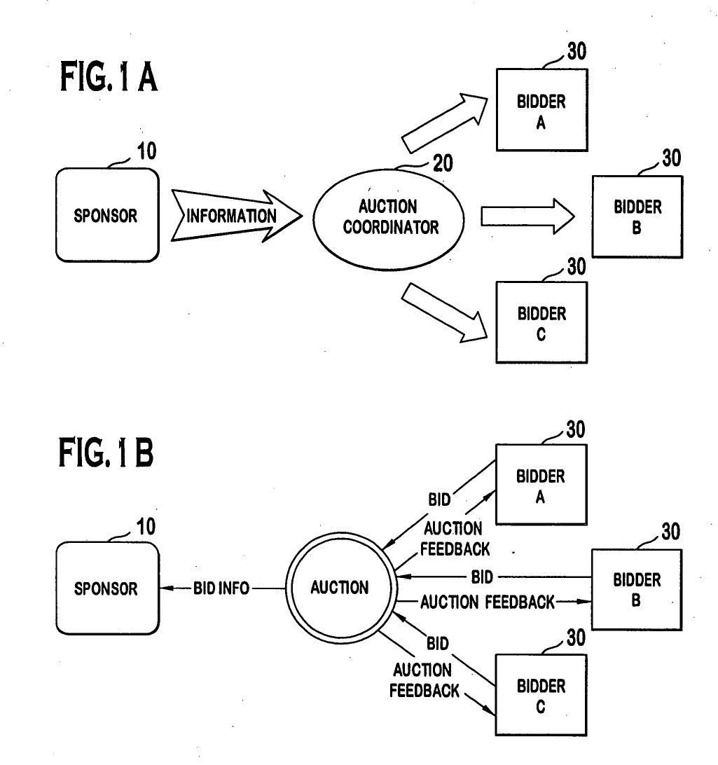

The basic process for a purchaser sponsored supplier-bidding or reverse auction, as conducted in present invention, is described below with reference to FIG. 1. FIG. 1 illustrates the functional elements and entities involved in setting up and conducting a typical supplier-bidding auction. FIG. 1A illustrates the creation of an auctioning event, and FIG. 1B illustrates the bidding during an auction.

In the supplier-bidding reverse auction model, the product or service to be purchased is, preferably, defined by the sponsor, or originator, 10 of the auction, as shown in FIG. 1A. Alternatively, the buyer may set up all or some of its own bidding events and find its own suppliers. The sponsor 10 could run the events through a market operations center, which is a facility where auctions are monitored and participants receive assistance, or run the events as a self-service option. Software may be provided to the sponsor 10 through a plug-in program or similar means. If the sponsor 10 decides to use the auctioning system of the present invention to procure products or services, the sponsor 10 may provide information to an auction coordinator 20. That information may include information about incumbent suppliers and historic prices paid for the products or services to be auctioned, for example. Preferably, the sponsor 10 also works with the auction coordinator 20 to define the products and services to be purchased in the auction and lot the products and services appropriately so that desired products and services can be procured using optimal auction dynamics.

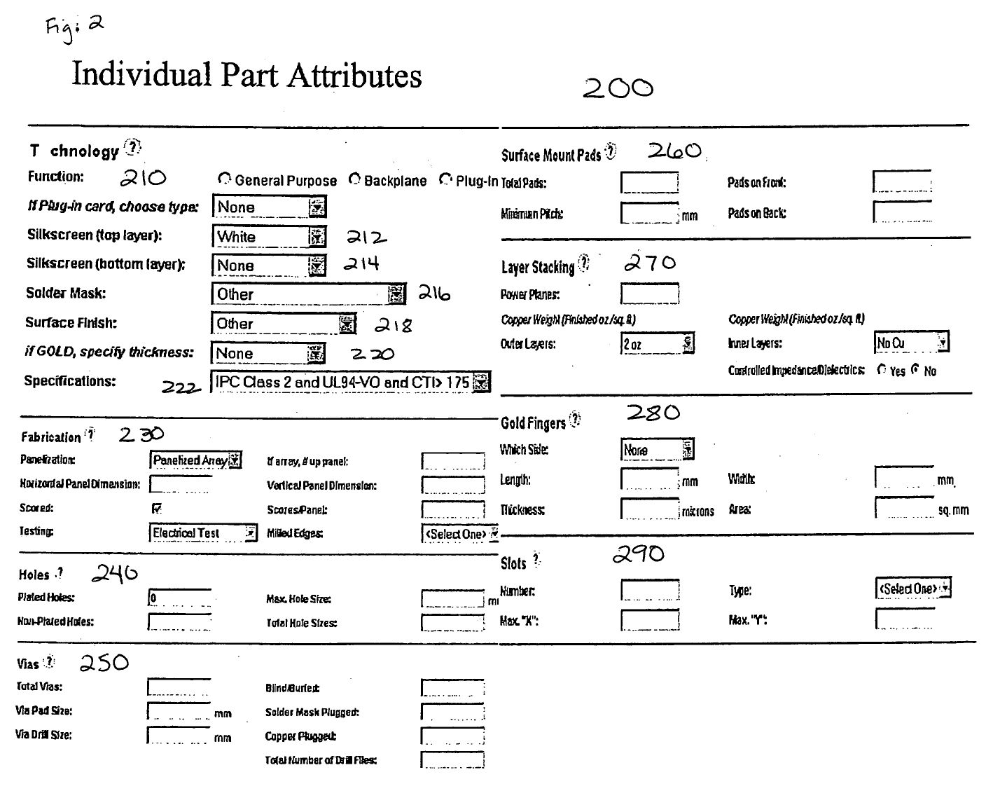

The lots are groupings of parts or materials having individual part attributes. These attributes may include operations, materials, processes, tolerances, or any other feature of a part. Before the auction, the individual part attributes are entered into a database. These attributes are specifications of the parts and range from materials to fabrications to sizes and weights, etc . . . FIG. 2 illustrates a graphical user interface (“GUI”) 200 used to select the individual attributes for a card. The GUI displays individual screens to describe the card's function 210, fabrication 230, holes 240, vias 250, surface mount pads 260, layer stacking 270, gold fingers 280 and slots 290. Within the function screen, the user enters the function type 210, top and bottom layers silkscreen 212, 214, the solder mask 216, surface finish 218, the thickness if a gold surface finish, 220 and the specifications 222. Likewise for the other screen sections, the user may add additional attributes.

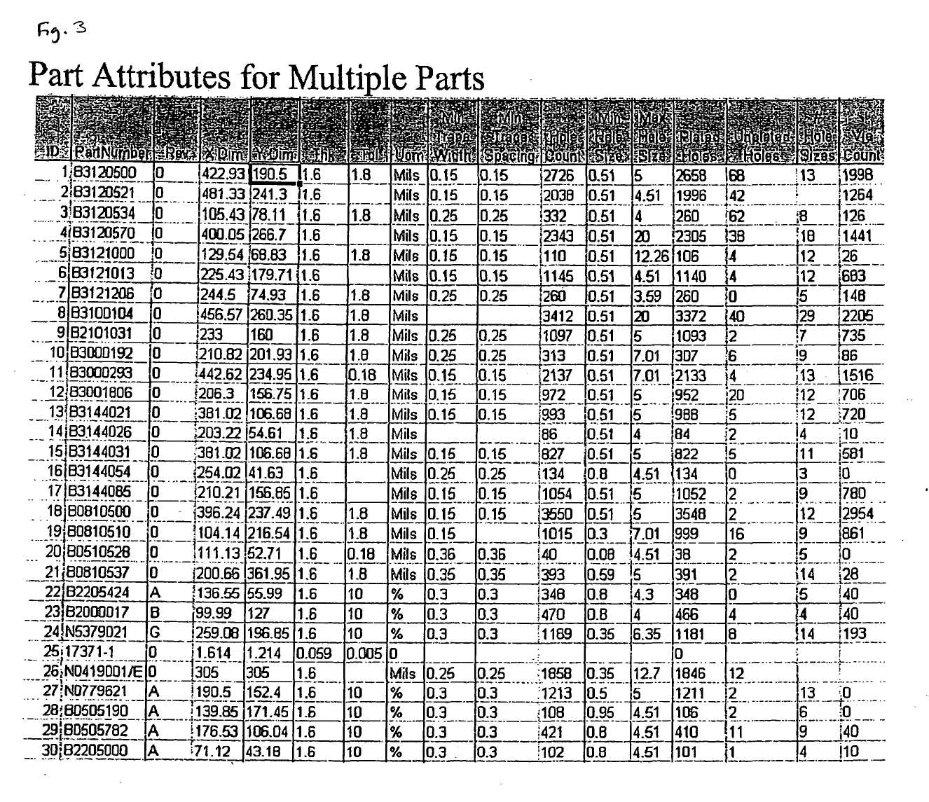

From the individual part attributes, a report or list may be generated, as shown in FIG. 3. For example, part number B2205000 (ID30) has a x-dimension of 71.12 and y-dimension of 43.18. This list is searchable and may be used with the method or system of this invention to automatically generate a lot with parts having desired attributes. For example, if a thickness of 1.6 is the desired attribute, a lot with all of the listed parts, except part number 1737-1 (ID25), will be generated. Part number 1737-1 (ID25) has a thickness of 0.059, so it does not have the desired attribute of 1.6 thickness. Similarly, if a maximum hole size of 8 or greater is the desired attribute, then a lot with part numbers B3120570 (ID4), B3121000 (ID5), B3100104 (ID8), and N0419001/E (ID26) will be generated.

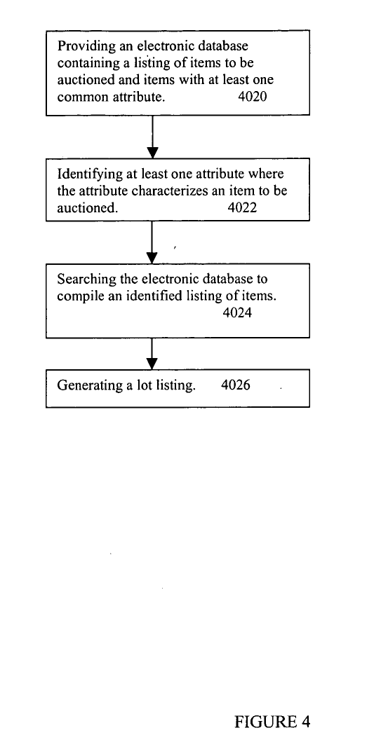

In one embodiment, an electronic database is provided containing a listing of items, including the items to be auctioned in step 4020, as shown in FIG. 4. Preferably, the electronic database also includes an attribute-based electronically searchable list of a plurality of attributes. Preferably, each item in the listing of items has at least one attribute and each attribute is common to a plurality of items in the listing of items. In step 4022, at least one attribute is identified where the attribute characterizes at least one of the items to be auctioned. In step 4024, the database is searched to compile an identified listing of items. Preferably, each item in the identified listing of items has the at least one identified attribute. The identified listing of items may also include an index of the total number of items for each identified attribute. Lastly in step 4026, a lot listing is generated from the identified listing of items.

In one example of the invention, the list of parts has 2204 parts with their individual part attributes. The parts may be divided into different groups, such as 61 parts having a null attribute, 432 parts having a drill attribute, 311 parts having a lathe attribute, 699 parts having a burr attribute, and 701 parts having an inspect attribute. The different groups for the specific attributes may or may not contain the same parts, i.e., the null attribute group may include part #35 and the lathe attribute may also include part #35, but the burr attribute group may not include part #35. If the desired attributes include drill, burr, and inspect, then a lot having these attributes will be generated.

The lot listing may be generated by including the items in the lot listing having all or any of the identified attributes. The lots may be generated by using “and”, “or”, and “or not” operators. For example, if the criteria includes each part having drill, burr, and inspect attributes, then no more than 432 parts (the maximum number of parts with the drill attribute) will be included in the lot. If all 432 parts having the drill attribute also have the burr and inspect attribute, all 432 parts will be included in the lot. However, if 100 parts have the drill attribute, but not the burr and inspect attributes, 100 parts have the burr attribute, but not the drill and inspect attributes, 50 parts have the drill and inspect attributes, and 182 parts have the drill, burr, and inspect attributes, then the lot will include the 182 parts with all of the attributes.

In another example, the criteria includes at least one attribute, i.e., each part having drill, burr, or inspect attributes. The resulting lot would include the 432 parts with the drill attribute, the 699 parts with the burr attribute, and the 701 parts with the inspect attribute.

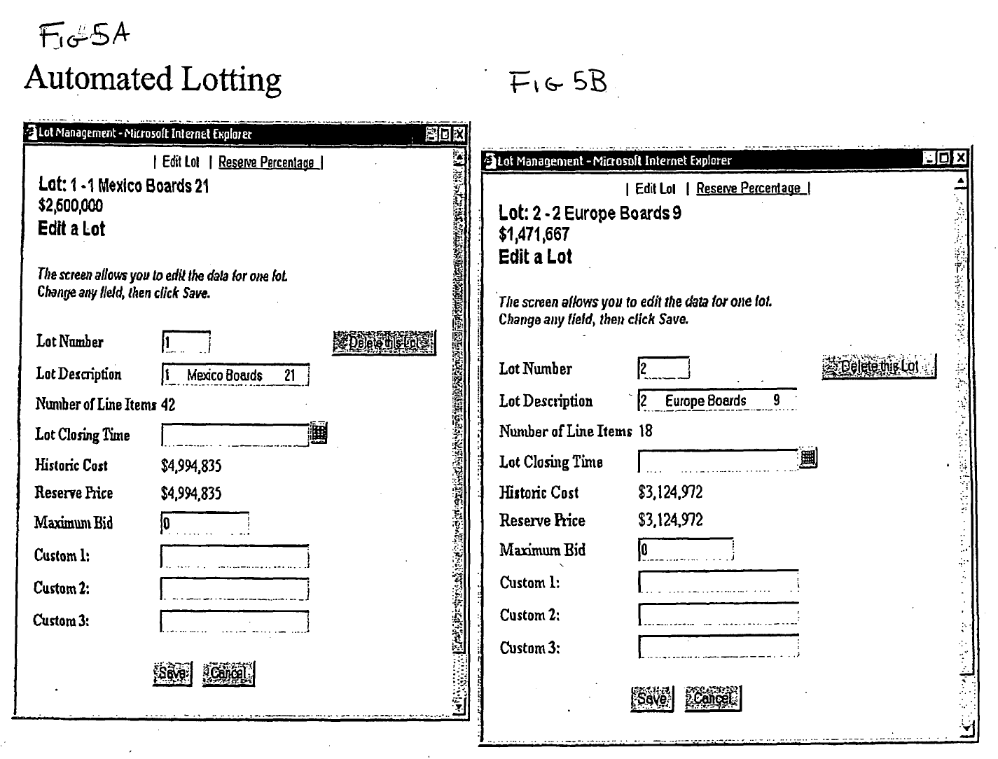

The criteria used to create a lot listing may also be defined by the sponsor or automatically generated by grouping parts with similar characteristics and prices together. Effective, logical groupings result. Because market makers are not experts in every commodity, the automation allows non-experts in certain commodities to become experts. In any event, the lot listings that are generated may be displayed in an organized manner, as shown in FIGS. 5A and 5B. The display may have additional information including historic cost, reserve price and other useful information for an electronic auction. The information displayed in FIGS. 5A and 5B may also be edited.

Another embodiment of the invention includes a machine readable code for creating a lot having a plurality of items to be auctioned in an electronic auction based on the common attributes of the items. The machine readable code includes: a first machine readable code that stores a listing of items, including the items to be auctioned; a second machine readable code that identifies at least one attribute of at least one of the items to be auctioned; a third machine readable code that searches the database to compile an identified listing of items; and a fourth machine readable code that generates a lot listing from the identified listing of items.

After the desired lots are created, a Request for Quotation (“RFQ”) may be generated for the auction. Next, the auction coordinator 20 may identify potential suppliers 30, preferably with input from the sponsor 10, and invite the potential suppliers 30 to participate in the upcoming auction. The suppliers 30 that are selected to participate in the auction may become bidders 30 and may be given access to the RFQ, typically through an RFQ in a tangible form, such as on paper or in an electronic format.

As shown in FIG. 1B, during a typical auction, bids are made for the lots. Bidders 30 may submit actual unit prices for all line items within a lot, however, the competition in an auction is typically based on the aggregate value bid for all line items within a lot. The aggregate value bid for a lot may, therefore, depend on the level and mix of line item bids and the quantity of goods or services that are offered for each line item. Thus, bidders 30 submitting bids at the line item level may actually be competing on the lot level. During the auction, the sponsor 10 may monitor the bidding as it occurs.

The auction may be conducted electronically between bidders 30 at their respective remote sites and the auction coordinator 20 at its site. Alternatively, instead of the auction coordinator 20 managing the auction at its site, the sponsor 10 may perform auction coordinator tasks at its site.

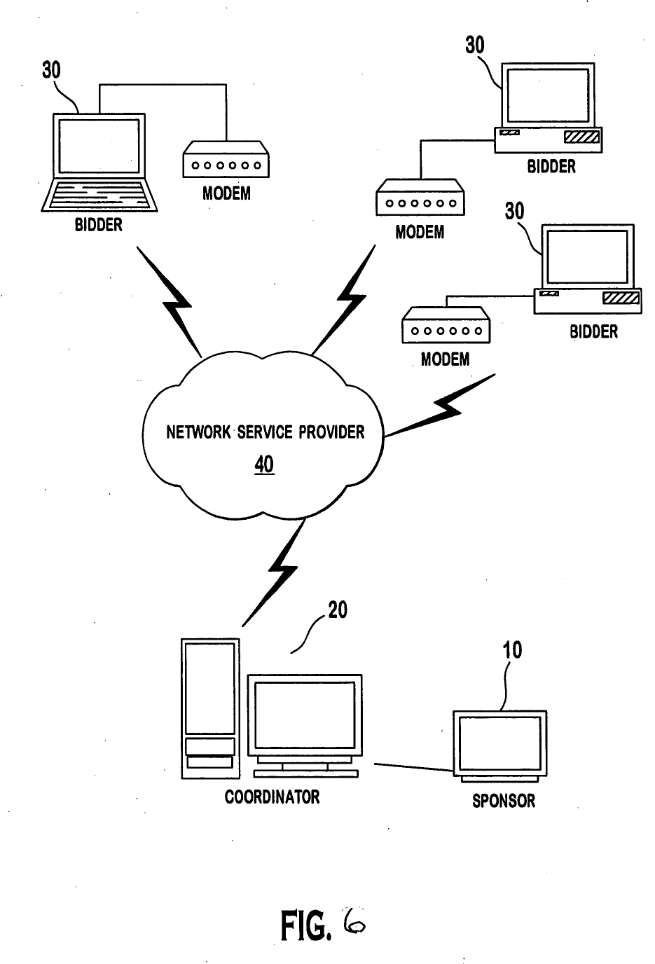

Information may be conveyed between the coordinator 20 and the bidders 30 via any communications medium. As shown in FIG. 6, bidders 30 may be connected to the auction through the Internet via a network service provider 40 accessed, for example, through a dial-up telephone connection. Alternatively, sponsors 10 and bidders 30 may be coupled to the auction by communicating directly with the auction coordinator 20 through a public switch telephone network, a wireless network, or any other connection.

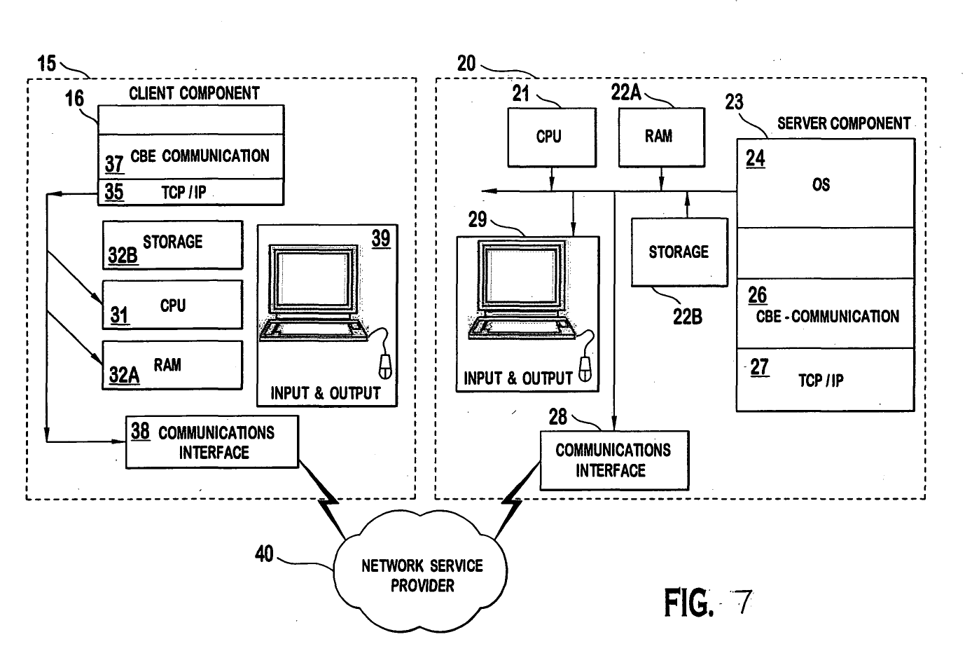

A computer software application may be used to manage the auction. Preferably, as shown in FIG. 7, the software application has two components: a client component 16 and a server component 23. The client component 16 may operate on a computer at the site of each of the potential suppliers 30. Suppliers 30 make bids during the auction using the client component 16. The bids may be sent via the network service provider 40 to the site of the coordinator, where it is received by the server component 23 of the software application. The client component 16 may include software used to make a connection through telephone lines or the Internet to the server component 23. Bids may be submitted over this connection and updates may be sent to the connected suppliers.

Bids may only be submitted using the client component 16 of the application. This ensures that buyers do not circumvent the bidding process, and that only invited suppliers participate in the bidding. Bidders may see their bids and bids placed by other suppliers for each lot on the client component 16. When a bidder submits a bid, that bid is sent to the server component 23 and evaluated to determine whether the bid is from an authorized bidder and whether the bid has exceeded a pre-determined maximum acceptable price. Bids placed by a supplier may be broadcast to all connected bidders, thereby enabling every participating bidder to quickly view the change in market conditions and begin planning their competitive responses.

With reference to FIG. 7, a computer system 20 operates to execute the functionality for server component 23. Computer system 20 includes a processor 21, a memory 22A and a disk storage 22B. Memory 22A stores computer program instructions and data. Processor 21 executes the program instructions or software, and processes the data, stored in memory 22A. Disk storage 22B stores data to be transferred to and from memory 22A. All these elements are interconnected by one or more buses, which allows data to be intercommunicated between the elements.

Processor 21 may be any type of processor capable of providing the speed and functionality required by the embodiments of the invention. For example, processor 21 could be a processor from a family of processors made by Intel Corporation or Motorola.

For purposes of this application, memory 22A and disk 22B are machine readable mediums and could include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g., floppy disk and hard drive), optical disk (e.g., CD-ROM), optical fiber, electrical signals, lightwave signals, radio-frequency (RF) signals and any other device or signal that can store digital information. In one embodiment, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, system 20 may contain various combinations of machine readable storage devices, which are accessible by processor 21 and which are capable of storing a combination of computer program instructions and data.

Memory 22A is accessible by processor 21 over a bus and includes an operating system, a program partition and a data partition. The program partition stores and allows execution by processor 21 of program instructions that implement the functions of each respective system described herein. The data partition is accessible by processor 21 and stores data used during the execution of program instructions. For some embodiments of the invention, the program partition contains program instructions that perform the buy versus leasing transformation functionality described above.

Computer system 20 also includes input and output devices 29, such as a monitor, printer, mouse, and keyboard, and a network interface 28. Network interface 28 may be any suitable means for controlling communication signals between network devices using a desired set of communications protocols, services and operating procedures. Communication protocols are layered, which is also referred to as a protocol stack, as represented by operating system 24, a CBE-communication layer 26, and a Transport Control Protocol/Internet Protocol (TCP/IP) layer 27. Network interface 28 also includes connectors for connecting interface 28 with a suitable communications medium. Those skilled in the art will understand that network interface 28 may receive communication signals over any suitable medium such as twisted-pair wire, co-axial cable, fiber optics, radio-frequencies, and so forth.

FIG. 7 also shows a computer system 15 that operates to execute the functionality for client component 16. Computer system 15 includes a processor 31, a memory 32A, disk storage 32B, a communications interface 38, input and output devices 39, and a protocol stack having a CBE-communication layer 37 and a TCP/IP layer 35. These elements operate in a manner similar to the corresponding elements for computer system 20.

While the invention has been described in detail and with reference to specific embodiments thereof, it will be apparent to one skilled in the art that various changes and modifications can be made therein without departing from the spirit and scope thereof.

What is claimed is:

1. A method for creating a lot having a plurality of items to be auctioned in an electronic auction based on common attributes of the items, comprising:
providing an electronic database containing a listing of items, including the items to be auctioned, each item in the listing of items having at least one attribute, each attribute being common to a plurality of items in the listing of items;
identifying at least one attribute of at least one of the items to be auctioned;
searching the database to compile an identified listing of items, each item in the identified listing of items having the at least one identified attribute; and
generating a lot listing from the identified listing of items.

2. The method of claim 1, wherein the electronic database comprises an attribute-based electronically searchable list of a plurality of attributes.

3. The method of claim 1, wherein the identified listing of items comprises an index of the total number of items per each identified attribute.

4. The method of claim 1, wherein the generating further comprises grouping attributes with similar characteristics and prices.

5. The method of claim 1, wherein the generating further comprises selecting the items in the lot listing having all of the identified attributes.

6. The method of claim 1, wherein the generating further comprises selecting the items in the lot listing having any of the identified attributes.

7. The method of claim 1, wherein the at least one attribute comprises at least one of an operation, material, fabrication, process, tolerance, size, weight, specification and any other feature of a part.

8. The method of claim 1, further comprising displaying the generated lots in an organized manner.

9. The method of claim 1, wherein the items to be auctioned comprise at least one of parts, materials, and components.

10. A method for creating a lot having a plurality of items to be auctioned in an electronic auction based on common attributes of the items, comprising:
providing an electronic database having an attribute-based electronically searchable list of a plurality of attributes and a listing of items, including the items to be auctioned, each item in the listing of items having at least one attribute, each attribute being common to a plurality of items in the listing of items;
identifying at least one attribute of at least one of the items to be auctioned;
searching the database to compile an identified listing of items, including each item in the identified listing of items having the at least one identified attribute and an index of the total number of items per each identified attribute; and
generating a lot listing from the identified listing of items by:
grouping attributes with similar characteristics and prices;
selecting the items in the lost listing having the identified attributes; and
displaying the generated lots in an organized manner.

11. A system for creating a lot having a plurality of items to be auctioned in an electronic auction based on common attributes of the items, comprising:
a database for storing a listing of items, including the items to be auctioned; and
software for:
choosing at least one attribute of at least one of the items to be auctioned;
searching the database to compile an identified listing of items; and
generating a lot listing from the identified listing of items.

12. The system of claim 11, wherein each item in the listing of items comprising at least one attribute, each attribute being common to a plurality of items in the listing of items.

13. The system of claim 11, wherein each item in the identified listing of items comprising the at least one identified attribute.

14. The system of claim 11, wherein the database further comprises an attribute-based electronically searchable list of a plurality of attributes.

15. The system of claim 11, wherein the software further comprises grouping attributes with similar characteristics and prices.

16. The system of claim 11, wherein the software further comprises generating the items in the lot listing having all of the identified attributes.

17. The system of claim 11, wherein the software further comprises generating the items in the lot listing having any of the identified attributes.

18. The system of claim 11, wherein the at least on attribute comprises at least one of an operation, material, fabrication, process, tolerance, size, weight, specification and any other feature of a part.

19. The system of claim 11, wherein the items to be auctioned comprise at least one of parts, materials, and components.

20. A machine readable medium that creates a lot having a plurality of items to be auctioned in an electronic auction based on common attributes of the items, comprising:
a first machine readable code that stores a listing of items, including the items to be auctioned;
a second machine readable code that identifies at least one attribute of at least one of the items to be auctioned;
a third machine readable code that searches the database to compile an identified listing of items; and
a fourth machine readable code that generates a lot listing from the identified listing of items.
